(19) United States
(12) Patent Application Publication
(10) Pub. No.: US 2008/0150961 A1
(43) Pub. Date: Jun. 26, 2008

(54) DISPLAYS WITH EMBEDDED COLOR TRACKING ALGORITHM BASED ON PANEL OPTICAL CHARACTERISTICS

(75) Inventor: Ter-Wei Peng, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, Taoyuan (TW)

(21) Appl. No.: 11/839,459

(22) Filed: Aug. 15, 2007

(30) Foreign Application Priority Data
Dec. 22, 2006 (TW) TW95148456

(51) Int. Cl. G09G 5/02

(52) U.S. Cl. 345/601

(57) ABSTRACT

Displays with embedded color tracking algorithm based on panel optical characteristics are disclosed for color tracking of displays. A display comprising a panel, a switch device, a memory unit and a color tracking unit is provided. The optical characteristics of the panel are obtained by optical measuring equipment, and the optical characteristics are written into an optical look up table stored in the memory unit. Also, according to the optical look up table and a color value, a look up table is generated by the color tracking unit for color correction.

### BACKGROUND OF THE INVENTION

1. Field of the Invention

The invention relates to displays, and in particular relates to displays with embedded color tracking algorithm based on panel optical characteristics.

2. Description of the Related Art

In recent years, color management and color tracking of displays has become important. Displays may offer kinds of color modes according to the demands of users, such as colorful, high luminance and high contrast. As displays show different contents, such as characters, images or videos, displays need different color modes to suitably display the contents. Color modes of displays are defined by color values. Color values comprise many terms, although generally speaking, gamma value and color temperature are the most important. For example, sRGB mode is defined by gamma 2.2 and color temperature 6500 K.

Color tracking of the conventional display presents colors by a gamma table stored in the display. A color mode needs a gamma table. Thus, if a display needs several color modes, several gamma tables must be stored in the display for users to switch between the different color modes. The color modes are defined by gamma value and color temperature. For example, 5 different gamma values and 13 different color temperatures derive 65 different color modes, requiring 65 gamma tables to be stored in the display.

Relevant tools for color tracking utilized in conventional displays require different algorithms, most parts obtain color tracking using user judgment or software algorithm executed by computers. The former requires time and effort and is not accurate. Although the latter saves times more and is more accurate, a large volume of memory space is still necessary to supply several gamma tables.

The conventional method for color tracking by software algorithms is to obtain panel optical characteristics, such as luminance or chroma by optical measuring equipment. A gamma table is derived from the measured optical characteristics and the color values in demand by the software algorithms. The gamma table is then written into the memory of the display. These steps are repeated several times to provide a display with several color modes. The color values are adjusted each time to obtain different gamma tables and the generated gamma tables will be written into the memory of the display one by one. However, although the method for color tracking by software algorithms saves manpower and increases the accuracy, it cannot improve the need for large volume of memory space to store the gamma tables.

### BRIEF SUMMARY OF INVENTION

A detailed description is given in the following embodiments with reference to the accompanying drawings.

A display with embedded color tracking algorithm based on panel optical characteristics is disclosed. The display comprises a panel, a memory unit, a switch device and a color tracking unit. The memory unit stores an optical look up table, and the optical look up table records at least one optical characteristic of the panel. The switch device is used to set at least a color value. The color tracking unit generates a gamma table according to the optical characteristic recorded in the optical look up table and the color value, and performs color tracking to correct the color of the panel according to the gamma table.

### BRIEF DESCRIPTION OF DRAWINGS

The invention can be more fully understood by reading the subsequent detailed description and examples with references made to the accompanying drawings, wherein:

FIG. 1 is a diagram illustrating the display in an embodiment of the invention;

FIG. 2 is a flowchart illustrating the processes executed by the disclosed color tracking algorithm embedded display in an embodiment of the invention; and

FIG. 3 is a flowchart illustrating the embedded color tracking procedure in an embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

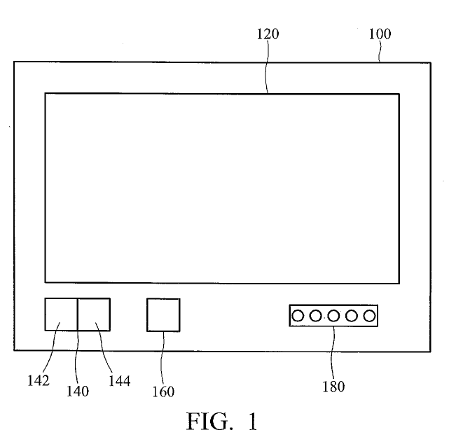

FIG. 1 is a diagram illustrating display 100 in an embodiment of the invention. Display 100 comprises a panel 120, a memory unit 140, a color tracking unit 160 and a switch device 180. Memory unit 140 comprises an optical look up table (OLUT) 140 and a gamma table 144. OLUT 140 stores optical characteristics of the panel 120 measured by optical measuring equipment. By the measuring of the optical measuring equipment, RGB characteristics will be obtained. The following table is a gamma table recording the relationships between gray levels and the RGB characteristics. The aforementioned optical characteristics are not limited to the RGB characteristics.

TABLE 1

| Gray levels | (X, Y, Z) (RGB characteristics) |
|---|---|
| 0 | (0.366, 0.568, 0.358) |
| . . . | . . . |
| 255 | . . . |

Gamma table is for color transformation. According to the gamma value and the color temperature selected by users, the output value corresponding to gray levels from 0 to 255 are calculated and are recorded in gamma table 144. The values recorded in Gamma table 144 are system values that may be accessed by a scalar or a timing controller (T-con). Before being updated according to OLUT 142, gamma table 144 may be a default gamma table.

Displays offer different color modes according to different needs. The color modes of displays are defined by color values. Users may define the color mode in demand by switching the color values such a gamma values or color temperatures via switch device 180. For example, the aforementioned switch device is on the display and the different color values can be switched by users via an on screen display (OSD). After switching the color values, for example a color temperature and a gamma value are selected, color tracking unit 160 accesses the optical characteristics in OLUT 142 from memory unit 140. Then, color tracking unit 160 recalculates a new gamma table and updates the original gamma table 144 (whether the default gamma table or not) by the new table to correct panel 120 with the new color mode. Color tracking 160 may be implemented by an application-specific integrate circuit (ASIC) based on a specific color tracking algorithm or a microprocessor executed based on a firmware.

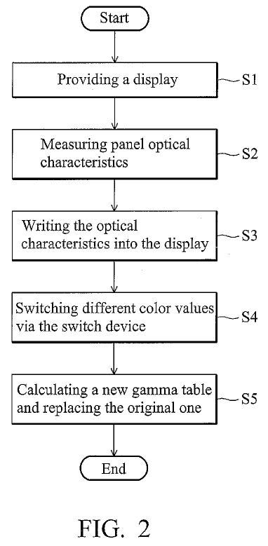

FIG. 2 is a flowchart illustrating the processes executed by the disclosed color tracking algorithm embedded display in the embodiment of the invention. First, display 100 in FIG. 1 is provided (S1), which comprises a panel 120, a memory unit 140, a color tracking unit 160 and a switch device 180. Optical characteristics of panel 120 are measured via optical measuring equipment and stored into memory unit 140 by OLUT 120 (S2 and S3). The optical measuring equipment may be a chroma meter or a color meter to measure the luminance or chroma of the centered illuminant of the panel.

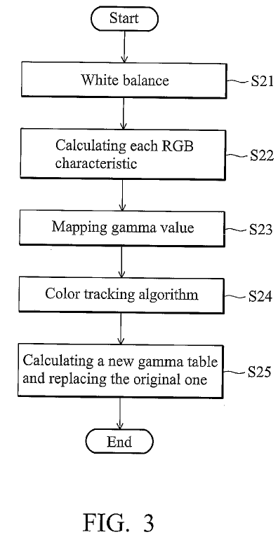

Color values such as gamma values or color temperatures are selected by users via switch device 180 of the display (S4). Color tracking unit 160 accesses the optical characteristics of panel 120 in OLUT 142 from memory unit 140 and calculates a new gamma table 144 according to the selected color values. After that, the original gamma table in memory unit 140 is replaced with the new table (S5). Color tracking unit 160 may perform color tracking referencing the color tracking procedure in FIG. 3. First, white balance of the panel is corrected (S21). Each RGB characteristic of the panel is calculated to obtain the mapping gamma values (S22 and S23). After obtaining the mapping gamma values, the panel may show the complete frame that is completed by the color tracking algorithm according to the gamma values (S24), and the original gamma table is replaced by the generated new table. (S25). And the kind of color tracking algorithm is not limited in the invention.

The disclosed display with embedded color tracking algorithm based on panel optical characteristics only needs to store the optical characteristics and one gamma table. As users switch different color modes in demand, the disclosed display will calculate a new gamma table immediately and the original gamma table will be replaced thereby. Thus, memory space needed for storing the gamma tables is efficiently decreased. Moreover, the time for display color tracking before producing is also decreased.

For example, if a display needs color modes consisting of 5 gamma values and 13 temperatures, according to the convention, 65 gamma tables need be stored in the memory of the display. Each gamma table comprises three values from RGB and each gray level is assumed to be recorded by 10 bits, then a gamma table needs 256×2³⁰ bits. If 65 gamma tables need being stored, the amount of memory space in demand is 65 times of 256×2³⁰ bits. In contrast to the conventional display, the disclosed display only needs the memory space for a gamma table. As users switch different color modes, the disclosed display will generate the corresponding gamma table immediately and the original gamma table will be replaced by the new table to achieve the goal for color mode switch. Therefore, the large volume of memory space for storing gamma tables corresponding to different color modes is unnecessary. Only 256×2³⁰ bits of memory space are needed for a gamma table.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display, comprising
a panel;
a memory unit to store an optical look up table, wherein the optical look up table records at least one optical characteristic of the panel;
a switch device to set at least a color value; and
a color tracking unit to generate a gamma table according to the optical characteristic recorded in the optical look up table and the color value, and to perform color tracking to correct the color of the panel according to the gamma table.

2. The display as claimed in claim 1, wherein the optical characteristic is a RGB characteristic of the panel measured via optical measuring equipment.

3. The display as claimed in claim 1, wherein the switch device is an onscreen display device.

4. The display as claimed in claim 1, wherein the color value is a gamma value or a color temperature.

5. The display as claimed in claim 1, wherein the gamma table records a system value accessible for a scalar or a timing controller (T-con).

6. The display as claimed in claim 1, wherein the display comprises a first gamma table.

7. The display as claimed in claim 6, wherein the color tracking unit generates a second gamma table according to the color value and the optical look up table, and replaces the first gamma table to correct the color of the panel.
